(19) United States
(12) Patent Application Publication
(10) Pub. No.: US 2007/0004255 A1
(43) Pub. Date: Jan. 4, 2007

(54) Electrical cable connector assembly with dustproof means

(75) Inventor: Peter Kuo, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/479,702

(22) Filed: Jun. 29, 2006

(30) Foreign Application Priority Data
Jul. 2, 2005 (CN) 200520073359.8

(51) Int. Cl. H01R 13/44

(52) U.S. Cl. 439/136

(57) ABSTRACT

An electrical cable connector assembly (1) includes a casing (10), an electrical connector (20) received in the casing (10), a cable (30) connecting with the electrical connector (20) and dustproof means (50). The electrical connector (20) defines a mating portion (21) protruding out of the casing (10) at distal end thereof, the dustproof means (50) includes a lid (51) mounting on the front end of the casing (10) and covering the mating portion (21) of the electrical connector (20), an engaging portion (54) for positioning the dustproof means (50) and a connecting portion (53) connecting with the lid (51) and the engaging portion (54). The casing (10) defines a matching portion (1030) to mate with the engaging portion (54).

### BACKGROUND OF THE INVENTION

1. Field of the Invention

The present invention relates to an electrical cable connector assembly, and particularly to an electrical cable connector assembly having dustproof means.

2. Description of the Prior Art

To establish an electrical connection between two electrical devices, an electrical cable connector assembly is demanded. Such an electrical cable connector assembly comprises two electrical connectors and a cable connecting with the electrical connectors. However, the electrical devices are not always in use, that is to say, the electrical cable connector assembly does not mate with the complementary connector all along. The electrical cable connector assembly is subject to dust under this circumstance, and the contacts of the electrical cable connector assembly blemished by the dirty or other substances will degrade the effect of the data-transmission between two electrical devices.

To overcome the defect mentioned above, please refer to FIG. 1, China issued patent No. CN2624450Y discloses an improved electrical cable connector assembly 1′. The electrical cable connector assembly 1′ comprises an insulative housing 10′, a plurality of contacts 20′ received in the insulative housing 10′, a cable 30′ and dustproof means 50′. The dustproof means 50′ comprises a body 51′ mounted on the front portion of the insulative housing 10′ for preventing dust from entering into the insulative housing 10′, a positioning portion 54′ encircled the cable 30′, and a connecting portion 53′ connecting with the body 51′ and the portioning portion 54′. Such dustproof means 50′ protect the contacts 20′ from dust effectively, however, this manner has its own disadvantages. Firstly, the dustproof means should be assembled to the cable 30′ before the cable 30′ is soldered on corresponding electrical device. Secondly, the dustproof means 50′ could not be tore down from the cable connector assembly 1′ after the assembly is accomplished. It is not convenient to change the dustproof means 50′ when the body 51′ is broken.

Hence, an improved electrical cable connector assembly is desired to overcome the disadvantages of the prior art.

### BRIEF SUMMARY OF THE INVENTION

Therefore, a main object of the present invention is to provide an electrical cable connector assembly having improved dustproof means.

To fulfill the above-mentioned object, an electrical cable connector assembly comprises a casing, an electrical connector received in the casing, a cable connecting with the connector and dustproof means. The electrical connector defines a mating portion protruding out of the casing at distal end thereof. The dustproof means comprises a lid mounting on the front end of the casing and covering the mating portion of the connector, an engaging portion for positioning the dustproof means and a connecting portion connecting with the lid and the engaging portion. The casing defines a matching portion to mate with the engaging portion.

Other objects, advantages and novel features of the invention will become more apparent from the following detailed description when taken in conjunction with the accompanying drawings.

### BRIEF DESCRIPTION OF THE DRAWINGS

The foregoing summary, as well as the following detailed description of the embodiments of the present invention, will be better understood when read in conjunction with the appended drawings. For the purpose of illustrating the invention, there are shown in the drawings embodiments which are presently preferred. As should be understood, however, the invention is not limited to the precise arrangements and instrumentalities shown. In the drawings:

FIG. 1 is a partially exploded, perspective view of a conventional electrical cable connector assembly;

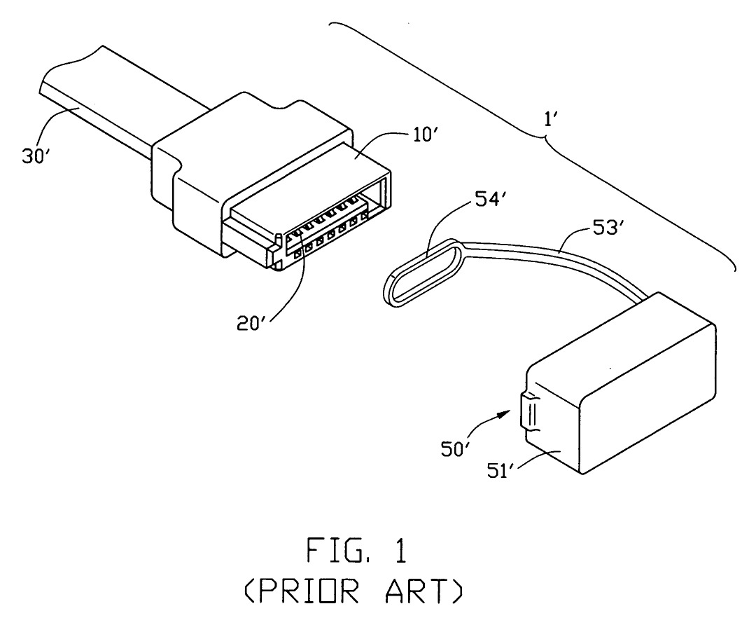

FIG. 2 is an assembled, perspective view of an electrical cable connector assembly according to the present invention;

FIG. 3 is a partially exploded, perspective view of the electrical cable connector assembly according to the present invention; and

FIG. 4 is a perspective view of dustproof means of the electrical cable connector assembly according to the present invention.

### DETAILED DESCRIPTION OF THE PREFERRED EMBODIMENT

Reference will now be made in detail to the preferred embodiment of the present invention.

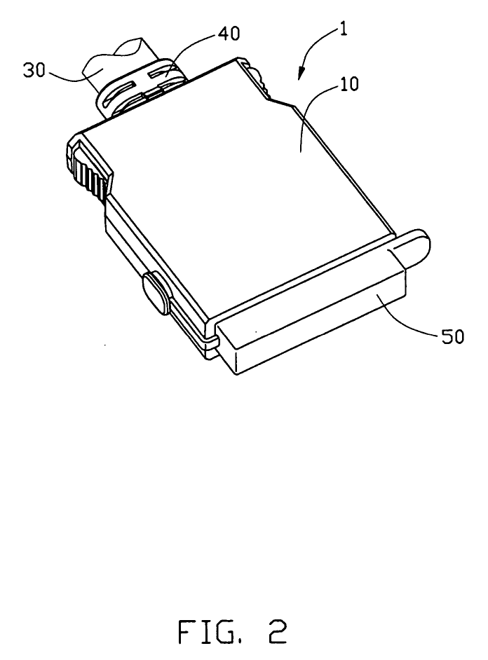

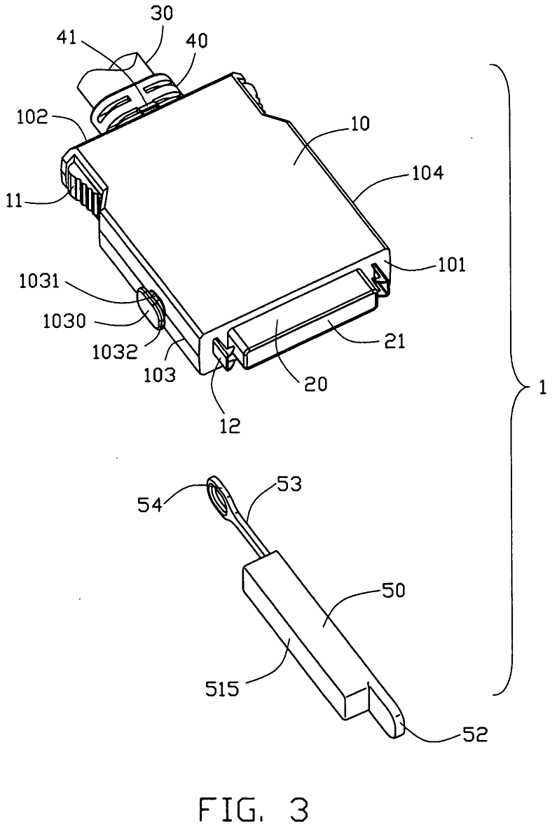

Referring to FIGS. 2-3, an electrical cable connector assembly 1 according to the present invention comprises a casing 10, an electrical connector 20 received in the casing 10, a cable 30 passing through the casing 10 and connecting with the electrical connector 20, a strain relief member 40 located behind the rear portion of the casing 10 and dustproof means 50 assembled to the front portion of the casing 10.

The casing 10 is made of plastic material, and dimensioned to be of rectangular shape. The casing 10 comprises a mating wall 101 engaging with an complementary connector (not shown), an engaging wall 102 opposite to the mating wall 101, and side walls 103, 104 formed between the mating wall 101 and the engaging wall 102. A pair of resilient pressing portions 11 are disposed at two recessed areas of the sides wall 103, 104 and adjacent to the engaging wall 102, and each resilient pressing portion 11 forms a plurality of frictional bulges (not labeled) for facilitating handling. A matching portion 1030 is formed on outer side of the side wall 103 and adjacent to the mating wall 101. The matching portion 1030 comprises a columnar base 1031 and an elliptical flange 1032 extending from the base 1031, and the area of the flange 1032 is larger than that of the base 1031. The electrical cable connector assembly 1 further comprises a pair of latches 12 located at two side walls 103, 104 and capable of being actuated by the pressing portions 11 for releasing engagement between the latches 12 and the complementary connector. The front ends of the latches are respectively disposed at two sides of the electrical connector 20.

The electrical connector 20 is a common electrical connector, and not limited by any kind. The electrical connector 20 comprises an insulative housing (not shown) and a plurality of terminals (not shown) received in the insulative housing. The insulative housing defines a mating portion 21 at a front end thereof projecting out of the mating wall 101.

Referring to FIGS. 2-3, the cable 30 comprises a plurality of inner conductors (not shown) connecting to the terminals of the electrical connector 20.

The strain relief member 40 is made of plastic material or polymeric material and is over-molded on the cable 30 and adjacent to the engaging wall 102 of the casing 10. The strain relief member 40 forms a pair of protrusions 41 respectively located on the upper and lower surfaces thereof.

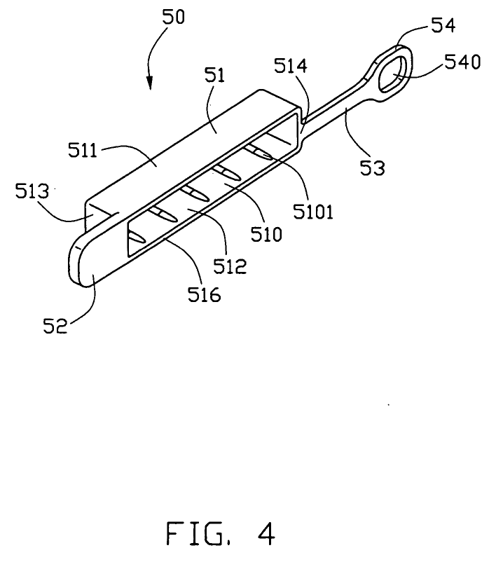

Referring to FIGS. 2 and 4, the dustproof means 50 is made of insulative material, and comprises a lid 51 assembled to face the mating wall 101 of the casing 10 and enclosing the mating portion 21 of the electrical connector 20, an engaging portion 54 for positioning the dustproof means 50 and a connecting portion 53 linking with the lid 51 and the engaging portion 54. The lid 51 is dimensioned to adapt to the electrical connector 20. The lid 51 defines an upper wall 511, a lower wall 512 parallel to the upper wall 511, side walls 513, 514, and a rear wall 515 jointing with the upper wall 511, the lower wall 512, and the side walls 513, 514. The walls 511, 512, 513, 514, 515 together form the receiving chamber 510. The receiving chamber 510 defines a plurality of ribs 5101 interferentially engaging with outer periphery of the mating portion 21 of the electrical connector 20. The connecting portion 53 extends away from the side wall 514. The engaging portion 54 is formed at the distal end of the connecting portion 53 and defines a through hole 540 dimensioned to match the matching portion 1030 of the casing 10. The size of the through hole 540 is slightly smaller than that of the flange 1032. The lid 51 further defines a handling member 52 extending from the side wall 513 and characterized as semi-elliptical shape.

In assembly, referring to FIGS. 2-4. Firstly, the plurality of terminals (not shown) are assembled to the electrical connector 20. Secondly, the inner conductors (not shown) of the cable 30 are respectively soldered with the terminals of the electrical connector 20, and then the casing 10 is moved from an end of the cable 30 and toward the electrical connector 20 to engage with the electrical connector 20 till the protrusions 41 of the strain relief member 40 resist the engaging wall 102 to retain the casing 10. Lastly, the dustproof means 50 is assembled to the casing 10 with the engaging portion 54 engaging with the base 1031 of the matching portion 1030. In addition, the lid 51 would be assembled to the casing 10 in some condition, not limited by a certain step.

When the electrical cable connector assembly 1 does not mate with a complementary connector, the lid 51 of the dustproof means 50 needs to be assembled onto the mating portion 21 of the electrical connector 20 projecting outwardly from the mating wall 101. That is to say, the mating portion 21 of the electrical connector 20 is received in the receiving chamber 510 and interferentially engages with the ribs 5101. Thus, the lid 51 can effectively enclose the mating portion of the electrical connector 20. In the preferred embodiment, the lid 51 encloses the electrical connector 20 and the latches 12 located at two sides of the mating portion 21 of the electrical connector 20 synchronously, thus, it can effectively prevent the dust and other substances from penetrating into the inner space of the electrical cable connector assembly 1.

When the electrical cable connector assembly 1 needs to mate with a complementary connector, the operator removes the lid 51 of the dustproof means 50 from the electrical connector 20 by drawing the handling member 52. In assembly, the operator pushes the handling member 52 to accomplish the assembly either. The present invention has some advantages as follows: firstly, the dustproof means 50 is not easy to be lost by means of the combination between the engaging portion 54 and the matching portion 1030; secondly, in assembly, the dustproof means 50 would be assembled in any step of the process; lastly, the dustproof means 50 could be changed freely when it is destroyed.

It is to be understood, however, that even though numerous, characteristics and advantages of the present invention have been set fourth in the foregoing description, together with details of the structure and function of the invention, the disclosed is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical cable connector assembly, comprising:
a casing;
a electrical connector received in said casing and defining a mating portion protruding out of the casing at distal end thereof;
a cable electrically connecting with said connector;
dustproof means comprising a lid mounting on the front end of the casing and covering the mating portion of the electrical connector, an engaging portion for positioning the dustproof means and a connecting portion connecting with the lid and the engaging portion; and wherein
said casing defines a matching portion to mate with said engaging portion of the dustproof means for retaining the dustproof means to the casing.

2. The electrical cable connector assembly as described in claim 1, wherein the matching portion of the casing comprises a base extending from the casing, a flange located on the top of the base, the area of the flange is larger than that of the base, and wherein the engaging portion of the dustproof means defines a through hole encircling the base of the matching portion and is stopped and retained by the flange.

3. The electrical connector as claimed in claim 2, wherein the size of said through hole is slightly smaller than that of the flange.

4. The electrical cable connector assembly as claimed in claim 1, wherein the casing is of rectangular shape and comprises a mating wall engaging with a complementary connector, an engaging wall opposite to the mating wall, and two sides walls connecting with the mating wall and engaging wall, and wherein said matching portion is located on one side wall of the casing.

5. The electrical cable connector assembly as claimed in claim 4, further comprising a pair of pressing portions assembled to the two side walls of the casing and adjacent to the engaging wall, and a pair of latches capable of actuated by said pair of pressing portions are located on the two sides of the mating portion of the connector adjacent to the mating wall and received in the lid.

6. The electrical cable connector assembly as claimed in claim 5, wherein the lid defines a handling member on one side wall thereof locating at front end of the casing.

7. The electrical cable connector assembly as claimed in claim 4, further comprising a strain relief member located on the cable and having a pair of protrusions engaging with the engaging wall of the casing.

8. The electrical cable connector assembly as claimed in claim 1, wherein the lid defines an upper wall, a lower wall parallel to the upper wall, two side walls, and a rear wall jointing with the upper wall, the lower wall, and the side walls, the walls together form a receiving chamber, and wherein said electrical connector is received in the receiving chamber.

9. The electrical cable connector assembly as claimed in claim 5, wherein the receiving chamber defines a plurality of ribs interferentially engaging with the mating portion of the electrical connector.

10. An electrical connector assembly comprising:
an insulative housing defining a mating port in a front portion thereof;
a plurality of contacts disposed in the mating port;
a cable extending from a rear portion of the housing;
a dustproof defining a lid mounted to and enclosing the mating port, an engaging portion attached to a lateral side of the housing, and a flexible connection portion connected between the lid and the engaging portion.

11. The assembly as claimed in claim 10, wherein said connection portion is connected to one end of said lid along a lengthwise direction of the mating port.

12. The assembly as claimed in claim 11, wherein a handle is formed at the other end of the lid.

13. The assembly as claimed in claim 10, wherein further including at least one deflectable latch located at a same side of the housing with said engaging portion.

14. The assembly as claimed in claim 13, wherein said lid encloses a tip of said latch.

15. The assembly as claimed in claim 10, wherein a length of said connection portion is smaller than that of the housing along a front-to-back direction of the housing.

16. An electrical connector assembly comprising:
an insulative housing defining a mating port in a front portion thereof;
a plurality of contacts disposed in the mating port;
a cable extending from a rear portion of the housing;
a dustproof defining an elongated lid mounted to and enclosing the mating port, and a flexible connection portion connected between the lid and the engaging portion; wherein
the connection portion is connected to one end of the lid along a lengthwise direction of said elongated lid.

17. The assembly as claimed in claim 16, wherein a handle is formed at the other end of the lid along said lengthwise direction.

18. The assembly as claimed in claim 16, wherein further including at least one deflectable latch located at a same side of the housing with said connection portion.

19. The assembly as claimed in claim 18, wherein said lid encloses a tip of said latch.

20. The assembly as claimed in claim 16, wherein a length of said connection portion is smaller than that of the housing along a front-to-back direction of the housing.
